(19) United States
(12) Patent Application Publication
(10) Pub. No.: US 2021/0055402 A1
(43) Pub. Date: Feb. 25, 2021

(54) SENSOR CIRCUIT WITH LEAKAGE-BASED LOCAL OSCILLATOR GENERATION

(71) Applicant: Apple Inc., Cupertino, CA (US)

(72) Inventors: Saihua Lin, Santa Clara, CA (US); Sohrab Emami-Neyestanak, San Francisco, CA (US); Hongrui Wang, San Diego, CA (US)

(21) Appl. No.: 16/549,689

(22) Filed: Aug. 23, 2019

(51) Int. Cl. G01S 13/34; H01Q 3/34; G01S 13/02; G01S 7/03

(52) U.S. Cl. CPC G01S 13/34; G01S 7/03; G01S 13/0209; H01Q 3/34

(57) ABSTRACT

A sensor circuit included in a computer system may include multiple antennae and transceiver circuits that include transmitter and receiver circuits. A particular transceiver circuit may transmit, via a particular antenna, a transmit signal that is a modulated version of a baseband signal, and generate a leakage signal based on leakage between transmitter and receiver circuits included in the particular transceiver circuit. A different transceiver circuit may generate a received signal using a reflected version of the transmitted signal that is received via a different antenna. An output signal may be generated using the received and leakage signals.

### BACKGROUND

### Technical Field

This disclosure relates to sensor circuits in computer systems and more particularly to radio frequency sensor circuit operation.

### Description of the Related Art

Modern computer systems may perform certain tasks or operations in response to changes in the environment, in which the computer systems are located. For example, changes in ambient light may result in a computer system adjusting brightness of a display. Additionally, changes in temperature may result in a computer system adjusting a level of processing being performed in order to maintain the computer system within designated thermal limits. In some cases, rapid changes in acceleration may result in the computer system taking certain actions to prevent damage to movable parts within the computer system.

To react to changes in environment, a computer system may include multiple sensor circuits designed to detect various effects or situations. For example, such sensor circuit may include temperature sensors, acceleration sensors, ambient light sensors, and the like. The outputs of such sensor circuits may be polled by a processor or controller included in the computer system to determine what actions to perform.

Sensor circuits, such as those described above, may include any suitable combination of logic circuits, analog circuit, radio frequency circuits, and the like. In some cases, the sensor circuits may employ passive sensing techniques. Other sensor circuits may employ active sensing by transmitting signals and monitoring any returning signals.

### SUMMARY OF THE EMBODIMENTS

Various embodiments of a sensor circuit are disclosed. Broadly speaking, a sensor circuit may includes first, second, and third transceiver circuits, and first, second, and third antenna, and an output circuit. The first transceiver circuit may be configured to transmit, via the first antenna, a transmit signal that is a modulated version of a baseband signal, and generate a leakage signal based on an amount of signal leakage of the transmit signal to a receiver circuit included in the first transceiver circuit. The second transceiver circuit may be configured to transmit, via the second antenna, the transmit signal. The third transceiver circuit may be configured to receive, via the third antenna, an echo signal that is a reflected version of the transmit signal and generate a received signal using the echo signal. The output circuit may be configured to generate an output signal using the received signal and the leakage signal

### BRIEF DESCRIPTION OF THE DRAWINGS

FIG. 1 is a block diagram of an embodiment of a sensor circuit.

FIG. 2 illustrates a block diagram of an embodiment of a transceiver circuit.

FIG. 3 illustrates a block diagram of another embodiment of a transmit/receive switch circuit.

FIG. 4 illustrates a block diagram of an output circuit.

FIG. 5 illustrates example transmitted and echo waveforms.

FIG. 6 illustrates a flow diagram depicting an embodiment of a method for generator a local oscillator signal in a sensor circuit.

FIG. 7 is a block diagram of one embodiment of a computer system that includes a power generator circuit.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112, paragraph (f) interpretation for that unit/circuit/component. More generally, the recitation of any element is expressly intended not to invoke 35 U.S.C. § 112, paragraph (f) interpretation for that element unless the language “means for” or “step for” is specifically recited.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. The phrase “based on” is thus synonymous with the phrase “based at least in part on.”

### DETAILED DESCRIPTION OF EMBODIMENTS

Many computer systems come equipped with various sensors that allow such computer systems to detect various effects and situations. For example, some mobile computer systems include sensors for detecting acceleration and deceleration, ambient temperature, humidity, and the like. In some cases, computer systems include sensors to determine a distance to a particular object. For example, sensors may be employed by a mobile computer system to determine a distance to a desktop computer system, router, etc.

Sensors used to determine a distance or range to an object may often employ radio frequency (RF) signals. Such signals may be transmitted and echo signals, i.e., versions of the transmitted signals reflected off of the object, may be received and analyzed to determine the distance or range to the object.

To maintain accuracy of the transmitted signal, a coupler may be employed that couples the output of a power amplifier circuit driving an antenna to an input of low noise amplifier. The output of the low noise amplifier is coupled to a local oscillator port of a mixer circuit that is also receiving an input from the receive path of the sensor circuit.

The use of the coupler at the output of the power amplifier circuit may degrade the efficiency of the power amplifier circuit. Such degradation can prove intolerable at millimeter wave frequencies. Moreover, the additional low noise amplifier circuit increases both overall circuit area and power consumption. The embodiments illustrated in the drawings and described below may provide techniques operating a sensor circuit that uses signal leakage through a transmit/receive switch to generate the local oscillator signal, thereby saving circuit area and reducing power consumption.

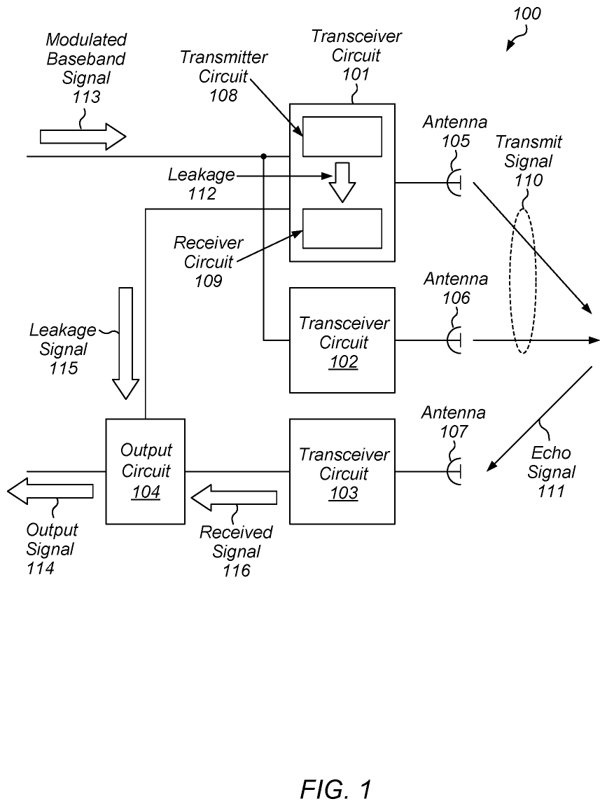

A block diagram of a sensor circuit is depicted in FIG. 1. As illustrated, sensor circuit 100 includes transceiver circuits 101-103, antennae 105-107, and output circuit 104. It is noted that although only three transceiver circuits and three antennae are depicted in the block diagram of FIG. 1, in other embodiments, any suitable number of both transceiver circuits and antennae may be employed.

Transceiver circuit 101 is configured to transmit, via antenna 105, transmit signal 110 that is a version of modulated baseband signal 113, and generate leakage signal 115 based on an amount of leakage 112 of transmit signal 110 to receiver circuit 109 included in transceiver circuit 101. Additionally, transceiver circuit 102 is configured to transmit, via antenna 106, transmit signal 110. It is noted that both antennae 105 and 106 may emit electromagnetic waves, which encode transmit signal 110, when driven by their respective transceiver circuits. In other embodiments, additional transceiver circuits may be included and may be configured to transmit, via respective antennae, transmit signal 110 for additional broadcast signal strength as well as part of beam forming of spatial filtering techniques.

As described below in more detail, transceiver circuit 101 may include a switch circuit coupled to a transmitter circuit included in transceiver circuit 101, where the transmitter circuit is configured to drive antenna 105 via the switch circuit using the transmit signal.

Transceiver circuit 103 is configured to receive, via antenna 107, echo signal 11 that is a reflected version of transmit signal 110 and is configured to generate received signal 116 using echo signal 111. It is noted that antenna 107 may generate a current that encodes echo signal 111 in response to receiving electromagnetic waves, which may be a reflected version of the electromagnetic waves generated by antennae 105 and 106. In other embodiments, additional transceiver circuits configured to receive, via respective antennae, echo signal 111 and generate respective received signals may be included. The multiple received signals may be combined using multiple combiner circuits to generate a composite receive signal.

It is noted that transceiver circuits 101-103 may each be different instances of a common transceiver circuit, and differences in functionality may be the result of different switch and enable signal configurations. Moreover, it is noted that the multiple transceiver circuits and antennae may be arranged in an array in order to implement beam forming or spatial filtering techniques used in conjunction with sensor circuit 100.

Output circuit 104 is configured to generate output signal 114 using received signal 116 and leakage signal 115. As described below in more detail, output circuit 104 may include multiple buffer circuits as well as a mixer circuit configured to generate output signal 114 using buffered versions of received signal 116 and leakage signal 115.

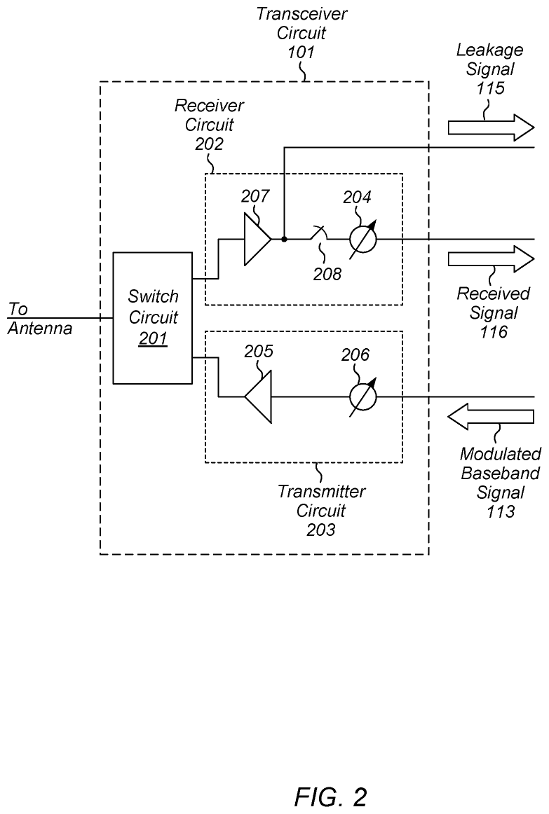

As noted above, the transceiver circuits depicted in FIG. 1 may be identical copies of a common circuit. Differences in configuration and enable signal settings for each copy may allow individual copies to function in either transmit mode or receive mode. An embodiment of a particular transceiver circuit, namely transceiver circuit 101, is depicted in FIG. 2. It is noted that the particular embodiment depicted in FIG. 2 may correspond to any of transceiver circuits 101-103 as illustrated in FIG. 1. As illustrated, transceiver circuit 101 includes switch circuit 201, receiver circuit 202, and transmitter circuit 203.

Receiver circuit 202 includes amplifier circuit 207, switch 208, and phase shifter circuit 204. Amplifier circuit 207, which may be a particular embodiment of a low noise or other suitable amplifier circuit, is configured to amplify a signal received from switch circuit 201. When transceiver circuit 101 is in transmit mode, switch 208 is open and amplifier circuit 207 amplifies leakage 112 from transmitter circuit 203 to generate leakage signal 115. Leakage 112 may, in various embodiments, occur via circuit components in switch circuit 201, or capacitive and/or inductive coupling between the output of amplifier circuit 205 (included in transmitter circuit 203) and the input of amplifier circuit 207.

When transceiver circuit 101 is operating in receive mode, switch 208 is closed and the output of amplifier circuit 207 is coupled to phase shifter circuit 204. In various embodiments, phase shifter circuit 204 is configured to phase shift the output of amplifier circuit 207 to generate received signal 116. Phase shifter circuit 204 may include any suitable combination of passive and active circuit components to generate a phase shift in the output of amplifier circuit 207. In some embodiments, the amount of phase shift generated by phase shifter circuit 204 may be programmable.

Transmitter circuit 203 includes amplifier circuit 205 and phase shifter circuit 206. Phase shifter circuit 206 is configured to add a phase shift to modulated baseband signal 113 to generate a phase-shifted signal as an input to amplifier circuit 205. Like phase shifter circuit 204, phase shifter circuit 206 may include any suitable combination of passive and active circuit elements configured to introduce a desired amount of phase shift into modulated baseband signal 113. In various embodiments, the amount of phase shift generated by phase shifter circuit 206 may be programmable.

Amplifier circuit 205 may, in some embodiments, be a particular embodiment of a power amplifier or other suitable amplifier circuit configured to drive an antenna, e.g., antenna 105, via switch circuit 201. In various embodiments, amplifier circuit 205 may amplify the output of phase shifter circuit 206 with a programmable gain value in order to generate transmit signal 110. When transceiver circuit 101 is operating in receive mode, power to amplifier circuit 205 may be reduced or eliminated in order to reduce power consumption.

Switch circuit 201 is configured to provide access to an antenna, e.g., antenna 105, to either receiver circuit 202 or transmitter circuit 203. For example, when operating in a transmit mode, transmitter circuit 203 has access to the antenna, while in a receive mode, receiver circuit 202 has access to the antenna. As described below in more detail, switch circuit 201 may include any suitable combination of devices and passive circuit elements.

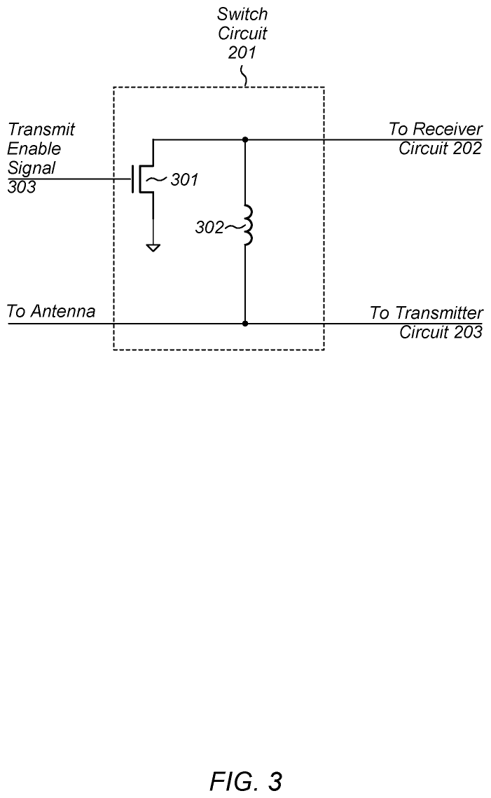

As described above, each of transceiver circuits 101-103 includes respective transmitter, receiver, and switch circuits, allowing the transceiver circuits to function as either a transmitter or receiver. Based on which mode of operation (e.g., transmit or receive) is desired, switch circuit 201 may operate differently allowing a pair of transmitter and receiver circuits included in a particular transceiver circuit to share a common antenna, e.g., antenna 105. An embodiment of switch circuit 201 is illustrated in FIG. 3. As illustrated, switch circuit 201 includes device 301 and inductor 302.

Device 301 is coupled to an input of receiver circuit 202 and a ground supply node. As depicted, device 301 is controlled by transmit enable signal 303, and may be a particular embodiment of either an n-channel metal-oxide semiconductor field-effect transistor (MOSFET). Alternatively, device 301 may be a p-channel MOSFET whose source terminal is connected to a power supply signal. In other embodiments, device 301 may be any suitable transconductance device including devices fabricated with technologies other than complementary metal-oxide semiconductor (CMOS) technology. For example, device 301 may include a junction field-effect transistor (DEFT), a bipolar transistor, or any other suitable device.

Inductor 302 is coupled between an input of receiver circuit 202 and transmitter circuit 203. In various embodiments, inductor 302 may be fabricated on a common silicon substrate with sensor circuit 100. In other embodiments, inductor 302 may be fabricated on a different silicon substrate than sensor circuit 100 and may be coupled to sensor circuit 100 using wiring available within a semiconductor chip package or other suitable mounting substrate. Although a single inductor is depicted in the embodiment illustrated in FIG. 3, in other embodiments, multiple inductors, as well as other passive and active circuit components may be employed.

When transceiver circuit 101 is operating in receive mode, transmit enable signal 303 is deactivated (also described as being “de-asserted”). As used herein, when a signal is deactivated, the signal is at a voltage level that is within a threshold value of ground potential such that an n-channel MOSFET is operating in sub-threshold or weak inversion mode. In some cases, a signal may be “active low,” in which case when the signal is de-asserted the signal is at a voltage level that is within a threshold value of a voltage level of a power supply signal such that a p-channel MOSFET is operating in sub-threshold or weak inversion mode. With transmit enable signal 303 deactivated, device 301 is disabled, i.e., not conducting, allowing signal received from antenna 105 to propagate to the input of receiver circuit 202. The combination of inductor 302 and the output impedance of transmitter circuit 203 results in a large impedance between antenna 105 and the output of transmitter circuit 203 so that the majority of the power associated with echo signal 111 is directed to receiver circuit 202. It is noted that transmit enable signal 303 may be generated within sensor circuit 100 or additional support circuits associated with sensor circuit 100.

When transceiver circuit 101 is operating in transmit mode, transmit enable signal 303 is activated (also referred to as being “asserted”). As used herein, an asserted signal has a voltage level that is sufficient to activate an n-channel MOSFET. Alternatively, an asserted active low signal has a voltage level that is sufficient to activate a p-channel MOSFET. With transmit enable signal 303 activated, device 301 is activated, which couples the input of receiver circuit 202 to a ground supply node. By coupling the input of receiver circuit to the ground supply node, transmitter circuit 203 is able to drive antenna 105 via inductor 302. Although device 301 is holding the input of receiver circuit 202 near ground potential, a portion of the transmitted signal may be amplified by receiver circuit 202, resulting in leakage 112.

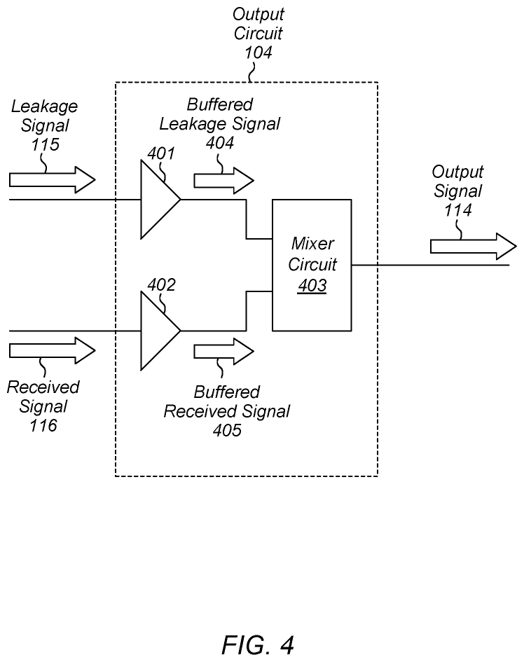

Turning to FIG. 4, a block diagram illustrating an embodiment of output circuit 104 is depicted. As illustrated, output circuit 104 includes buffer circuits 401 and 204, and mixer circuit 403.

Buffer circuit 401 is configured to generate buffered leakage signal 404 using leakage signal 115. In various embodiments, buffered leakage signal 404 may be similar to leakage signal 115 with a phase shift resulting from buffer circuit 401. A magnitude of buffered leakage signal 404 may, in some embodiments, be the same as a magnitude of leakage signal 115.

Buffer circuit 402 is configured to generate buffered received signal 405 using received signal 116. Like buffered leakage signal 404, buffered received signal 405 may be similar to received signal 116, with the additional of a phase shift associated with buffer circuit 402. In some embodiments, a magnitude of buffered received signal 405 may be the same as a magnitude of received signal 116.

Both buffer circuit 401 and buffer circuit 402 may be particular embodiments of unity gain amplifier circuits, configured to provide drive for leakage signal 115 and received signal 116 without changing the respective amplitudes of the signals. For example, buffer circuits 401 and 402 may be operational amplifiers (commonly referred to as “op amps”), or other suitable amplifier circuits, arranged in a unity gain configuration.

Mixer circuit 403 is coupled to buffer circuits 401 and 402, and is configured to generate output signal 114 using buffered leakage signal 404 and buffered received signal 405. In various embodiments, mixer circuit 403 may be configured to combine or “mix” buffered leakage signal 404 and buffered received signal 405 together such that a frequency of output signal 114 is based, at least in part, of respective frequencies of buffered leakage signal 404 and buffered received signal 405. For example, in some embodiments, the frequency of output signal 114 may be a difference of a frequency of buffered received signal 405 and a frequency of buffered leakage signal 404.

In some embodiments, mixer circuit 403 may be a passive mixer circuit that includes multiple passive circuit elements that may include one or more diodes or other suitable non-linear circuit elements. Alternatively, mixer circuit 403 may be an active mixer circuit that may include an amplifier, or other suitable circuit, configured to provide additional drive strength to output signal 114.

Structures such as those shown in FIGS. 2-4 for transmitting and receive signals may be referred to using functional language. In some embodiments, these structures may be described as including “a means for transmitting, via a first antenna of a plurality of antennae, a transmit signal that is a modulated version of a baseband signal” “a means for generating a leakage signal based on an amount of signal leakage of the transmit signal to a receiver circuit included in the first transceiver circuit,” and “a means for transmitting, via a second antenna of the plurality of antennae, the transmit signal,” “a means for receiving, via a third antenna of the plurality of antennae, an echo signal that is a reflected version of the transmit signal and generate a received signal using the echo signal,” and “a means for generating an output signal using the received signal and the leakage signal.”

The corresponding structure for “means for transmitting, via a first antenna of a plurality of antennae, a transmit signal that is a modulated version of a baseband signal” is transmitter circuit 203 and switch circuit 201, and their equivalents. The corresponding structure for “means for generating a leakage signal based on an amount of signal leakage of the transmit signal to a receiver circuit included in the first transceiver circuit” is switch circuit 201 and receiver circuit 202, and their equivalents. Transmitter circuit 203 and switch circuit 201, as well as their equivalents, are the corresponding structure for “means for transmitting, via a second antenna of the plurality of antennae, the transmit signal.” The corresponding structure for “means for receiving, via a third antenna of the plurality of antennae, an echo signal that is a reflected version of the transmit signal and generate a received signal using the echo signal” is switch circuit 201 and receiver circuit 202 and their respective equivalents. The corresponding structure for “means for generating an output signal using the received signal and the leakage signal” is buffer circuits 401 and 402, and mixer circuit 403, as well as their respective equivalents.

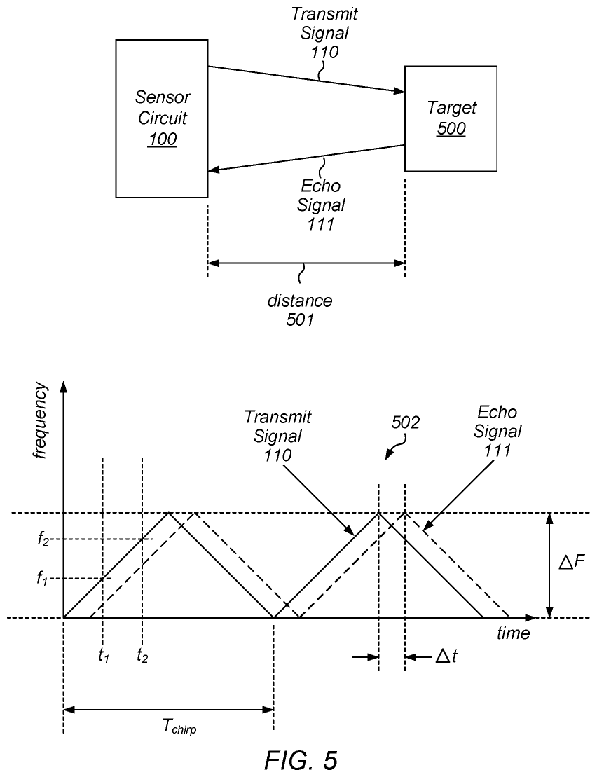

To illustrate how sensor circuit 100 can determine a distance to an object or target, example waveforms of transmit signal 110 and echo signal 111 are depicted in FIG. 5. As illustrated, sensor circuit 100 emits transmit signal 110, which is reflected off of target 500 to generate echo signal 111. Sensor circuit 100 is located distance 501 from target 500.

Since transmit signal 110 is modulated by a modulation signal, the frequency of transmit signal 108, varies in time as illustrated in graph 502. For example, at time t1, the frequency of transmit signal 108 is f₁, while at time t₂, the frequency of transmit signal 108 is f₂.

The change in frequency of transmit signal 110 from its minimum frequency value to its maximum frequency value is given by ΔF. The period during which transmit signal 110 transitions from its minimum frequency value, to its maximum frequency value, back to its minimum frequency value is denoted by T_{chirp}.

As noted above, echo signal 111 is a reflected version of transmit signal 110. Due to the transit time from sensor circuit 100 to target 500, and then back to sensor circuit 100, echo signal 111 is delayed from transmit signal 110 by Δt. By knowing Δt and the speed with which transmit signal 110 and echo signal 111 propagate, e.g., the speed of light, a value for distance 501 can be determined.

Rather than trying to determine the delay in receiving echo signal 111, distance 501 can be determined based on the baseband frequency of echo signal 111 once it has been down converted and filtered. As described above, one or more circuits can filter and convert output signal 114 from the time domain into the frequency domain using a discrete Fourier transform, thereby determining the baseband frequency. Distance 501 can then be determined using Equation 1, where f_{BB} is the baseband frequency, ΔF is the difference between the maximum and minimum frequency values of transmit signal 110, T_{chirp} is the period of a modulation signal, r_{target} is the distance to the target, i.e., distance 501, and c is the speed of light. In various embodiments, a dedicated circuit may determine f_{BB} and another circuit, e.g., a processor, may perform a calculation to determine r_{target}, while in other embodiments, the dedicated circuit may also determine r_{target} once the determination of f_{BB} has been made. It is noted that the description above is one particular method for operating sensor circuit 100 that may be used to determine a distance to an object. Other methods for determining the distance, including measurement of time of flight of the transmit and echo signals, as well as other uses for sensor circuit 100 are possible and contemplated.

$${f}_{BB} = \frac{Δ F}{{T}_{chirp}} \frac{2 {r}_{target}}{c} \qquad ( 1 )$$

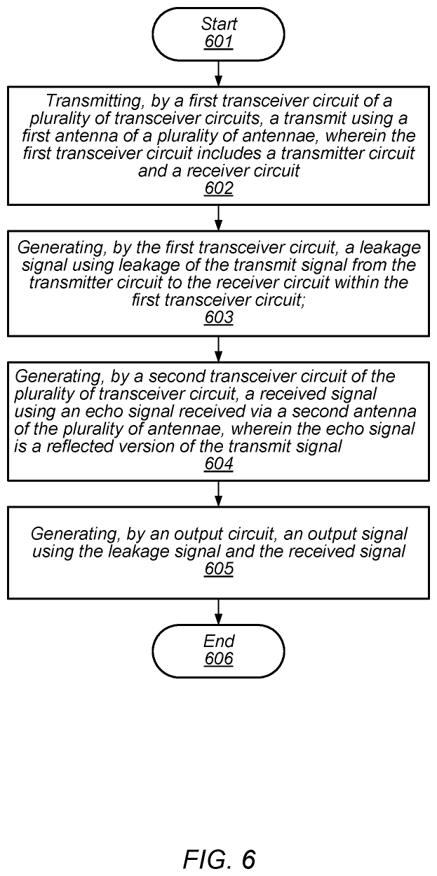

Turning to FIG. 6, a flow diagram illustrating an embodiment of a method for operating a sensor circuit is depicted. The method, which may be applied to sensor circuit 100 or any other suitable sensor circuit, begins in block 601.

The method includes transmitting, by a first transceiver circuit of a plurality of transceiver circuits, a transmit using a first antenna of a plurality of antennae, wherein the first transceiver circuit includes a transmitter circuit and a receiver circuit (block 602). In some embodiments, the transmit signal may be a modulated version of a baseband signal. Transmitting the transmit signal may, in various embodiments, include coupling an input of the receiver circuit to a ground supply node, in response to asserting a transmit enable signal.

Additionally, in various embodiments, the method may include phase shifting the transmit signal to generate a phase shifted transmit signal, and amplifying the phase shifted transmit signal to drive the first antenna. In some embodiments, the method may also include coupling an input of the receiver circuit and an output of the transmitter circuit using an inductor included in a switch circuit.

In some embodiments, the method may further include, transmitting, by a third transceiver circuit of the plurality of transceiver circuits, the modulated version of the baseband signal using a third antenna of the plurality of antennae.

The method also includes generating, by the first transceiver circuit, a leakage signal using leakage of the transmit signal from the transmitter circuit to the receiver circuit within the first transceiver circuit (block 603).

The method further includes generating, by a second transceiver circuit of the plurality of transceiver circuits, a received signal using an echo signal received via a second antenna of the plurality of antennae, wherein the echo signal is a reflected version of the transmit signal (block 604). In some embodiments, generating the received signal may include amplifying the echo signal to generate an amplified signal and phase shifting the amplified signal to generate the received signal.

The method also includes generating, by an output circuit, an output signal using the leakage signal and the received signal (block 605). In various embodiments, generating the output signal may include buffering the leakage signal to generate a buffered leakage signal, and buffering the receiving signal to generate a buffered received signal. In such cases, the method may also include mixing the buffered leakage signal and the buffered received signal to generate the output signal. The method concludes in block 606.

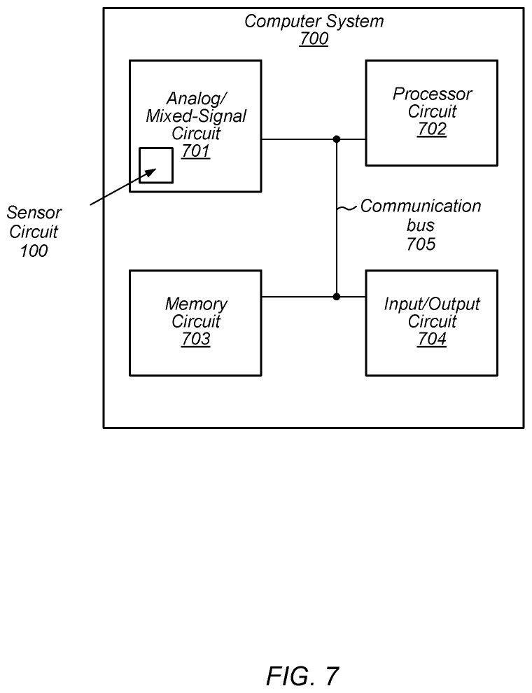

A block diagram of computer system is illustrated in FIG. 7. As illustrated embodiment, the computer system 700 includes analog/mixed-signal circuits 701, processor circuit 702, memory circuit 703, and input/output circuits 704, each of which is coupled to communication bus 705. In various embodiments, computer system 700 may be a system-on-a-chip (SoC) and be configured for use in a desktop computer, server, or in a mobile computing application such as, a tablet, laptop computer, or wearable computing device.

Analog/mixed-signal circuits 701 includes a variety of circuits includes sensor circuit 100. Additionally, analog/mixed-signal circuits 701 may include a crystal oscillator circuit, a phase-locked loop (PLL) circuit, an analog-to-digital converter (ADC) circuit, and a digital-to-analog converter (DAC) circuit (all not shown). In other embodiments, analog/mixed-signal circuits 701 may be configured to perform power management tasks with the inclusion of on-chip power supplies and voltage regulators.

Processor circuit 702 may, in various embodiments, be representative of a general-purpose processor that performs computational operations. For example, processor circuit 702 may be a central processing unit (CPU) such as a microprocessor, a microcontroller, an application-specific integrated circuit (ASIC), or a field-programmable gate array (FPGA).

Memory circuit 703 may in various embodiments, include any suitable type of memory such as a Dynamic Random-Access Memory (DRAM), a Static Random-Access Memory (SRAM), a Read-Only Memory (ROM), Electrically Erasable Programmable Read-only Memory (EEPROM), or a non-volatile memory, for example. It is noted that in the embodiment of a computer system in FIG. 7, a single memory circuit is depicted. In other embodiments, any suitable number of memory circuits may be employed.

Input/output circuits 704 may be configured to coordinate data transfer between computer system 700 and one or more peripheral devices. Such peripheral devices may include, without limitation, storage devices (e.g., magnetic or optical media-based storage devices including hard drives, tape drives, CD drives, DVD drives, etc.), audio processing subsystems, or any other suitable type of peripheral devices. In some embodiments, input/output circuits 704 may be configured to implement a version of Universal Serial Bus (USB) protocol or IEEE 1394 (Firewire®) protocol.

Input/output circuits 704 may also be configured to coordinate data transfer between computer system 700 and one or more devices (e.g., other computing systems or integrated circuits) coupled to computer system 700 via a network. In one embodiment, input/output circuits 704 may be configured to perform the data processing necessary to implement an Ethernet (IEEE 802.3) networking standard such as Gigabit Ethernet or 10-Gigabit Ethernet, for example, although it is contemplated that any suitable networking standard may be implemented. In some embodiments, input/output circuits 704 may be configured to implement multiple discrete network interface ports.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a plurality of transceiver circuits each coupled to a respective one of a plurality of antennae;
wherein a first transceiver circuit of the plurality of transceiver circuit is configured to:
transmit, via a first antenna of the plurality of antennae, a transmit signal that is a modulated version of a baseband signal; and
generate a leakage signal based on an amount of signal leakage of the transmit signal to a receiver circuit included in the first transceiver circuit;
wherein a second transceiver circuit of the plurality of transceiver circuits is configured to transmit, via a second antenna of the plurality of antennae, the transmit signal;
wherein a third transceiver circuit of the plurality of transceiver circuits is configured to receive, via a third antenna of the plurality of antennae, an echo signal that is a reflected version of the transmit signal and generate a received signal using the echo signal; and
an output circuit configured to generate an output signal using the received signal and the leakage signal.

2. The apparatus of claim 1, wherein the first transceiver circuit includes a switch circuit coupled to a transmitter circuit that is configured to drive the first antenna via the switch circuit using the transmit signal.

3. The apparatus of claim 2, wherein the transmitter circuit includes:
a phase shifter circuit configured to generate a phase-shifted signal using the transmit signal; and
a first amplifier circuit configured to drive the first antenna via the switch circuit using the phase-shifted signal.

4. The apparatus of claim 3, wherein the receiver circuit includes a second amplifier circuit configured to amplify the signal leakage propagating through the switch circuit to generate the leakage signal.

5. The apparatus of claim 3, wherein the switch circuit includes an inductor coupled between respective inputs of the receiver circuit and the transmitter circuit, and a device coupled to an input of the receiver circuit and configured to couple the input of the receive circuit to a ground supply node using a transmit enable signal.

6. The apparatus of claim 1, wherein the output circuit includes:
a first buffer circuit configured to generate a buffered version of the received signal;
a second buffer circuit configured to generate a buffered version of the leakage signal; and
a mixer circuit configured to generate the output signal using the buffered version of the received signal and the buffered version of the leakage signal.

7. A method, comprising:
transmitting, by a first transceiver circuit of a plurality of transceiver circuits, a transmit signal using a first antenna of a plurality of antennae, wherein the first transceiver circuit includes a transmitter circuit and a receiver circuit;
generating, by the first transceiver circuit, a leakage signal using leakage of the transmit signal from the transmitter circuit to the receiver circuit within the first transceiver circuit;
generating, by a second transceiver circuit of the plurality of transceiver circuit, a received signal using an echo signal received via a second antenna of the plurality of antennae, wherein the echo signal is a reflected version of the transmit signal; and
generating, by an output circuit, an output signal using the leakage signal and the received signal.

8. The method of claim 7, further comprising, transmitting, by a third transceiver circuit of the plurality of transceiver circuits, the transmit signal using a third antenna of the plurality of antennae.

9. The method of claim 7, wherein the transmit signal is a modulated version of a baseband signal.

10. The method of claim 7, wherein generating the output signal includes:
buffering the leakage signal to generate a buffered leakage signal;
buffering the received signal to generate a buffered received signal; and
mixing the buffered leakage signal and the buffered received signal to generate the output signal.

11. The method of claim 7, further comprising:
phase shifting the transmit signal to generate a phase-shifted transmit signal; and
amplifying the phase shifted transmit signal to drive the first antenna.

12. The method of claim 7, further comprising, coupling an input of the receiver circuit and an output of the transmitter circuit using an inductor included in a switch circuit.

13. The method of claim 7, wherein transmitting the transmit signal includes coupling an input of the receiver circuit to a ground supply node in response to asserting a transmit enable signal.

14. The method of claim 7, wherein generating the received signal includes:
amplifying the echo signal to generate an amplified signal; and
phase shifting the amplified signal to generate the received signal.

15. An apparatus, comprising:
a plurality of antennae;
a plurality of switch circuits coupled to the plurality of antennae;
a plurality of transmitter circuits including a first transmitter circuit coupled to a first switch circuit of the plurality of switch circuits, wherein the first switch circuit is coupled to a first antenna of the plurality of antennae, wherein the first transmitter circuit is configured to transmit, via the first antenna of the plurality of antennae, a transmit signal that is a modulated version of a baseband signal;
a plurality of receiver circuits including a first receiver circuit coupled to the first switch circuit, wherein the first receiver circuit is configured to generate a leakage signal based on an amount of signal leakage of the transmit signal to a receiver circuit included in the first transmitter circuit;
wherein a second receiver circuit of the plurality of receiver circuits is coupled to a second switch circuit of the plurality of switch circuits, wherein the second switch circuit is coupled to a second antenna of the plurality of antennae, wherein the second receiver circuit is configured to receive, via the second antenna, an echo signal that is a reflected version of the transmit signal and generate a received signal using the echo signal; and
an output circuit configured to generate an output signal using the received signal and the leakage signal.

16. The apparatus of claim 15, wherein a second transmitter circuit of the plurality of transmitter circuits is coupled to a third switch circuit of the plurality of switch circuits, wherein the third switch circuit is coupled to a third antenna of the plurality of antennae, wherein the second transmitter circuit is configured to transmit, via the third antenna, the transmit signal.

17. The apparatus of claim 15, wherein the first switch circuit includes an inductor coupled between an output of the first transmitter circuit and an input of the first receiver circuit, and wherein the first switch circuit is configured to couple the input of the first receiver circuit to a ground supply node using a transmit enable signal.

18. The apparatus of claim 15, wherein the first transmitter circuit is further configured to:
a phase-shifted signal using the transmit signal; and
drive the first antenna via the first switch circuit using the phase-shifted signal.

19. The apparatus of claim 15, wherein the first receiver circuit is configured to amplify a signal propagating through the first switch circuit to generate the leakage signal.

20. The apparatus of claim 15, wherein the output circuit is further configured to:
generate a buffered version of the received signal;
generate a buffered version of the leakage signal; and
generate the output signal using the buffered version of the received signal and the buffered version of the leakage signal.
